(19) United States
(12) Patent Application Publication
(10) Pub. No.: US 2026/0353172 A1
(43) Pub. Date: Nov. 5, 2026

(54) METHODS AND APPARATUSES FOR ADAPTIVE CONCATENATION IN NR L2

(71) Applicant: InterDigital Patent Holdings, Inc., Wilmington, DE (US)

(72) Inventors: Tuong Hoang, Montreal (CA); Faris Alfarhan, Montreal (CA); Samuli Turtinen, Ii (FI); Chia-Hung Wei, Chesterbrook, PA (US); Martino Freda, Laval (CA); Brian Martin, Farnham (GB); Keiichi Kubota, Setagaya-Ku (JP); Oumer Teyeb, Montreal (CA); Francois Periard, Montreal (CA); Pascal Adjakple, Great Neck, NY (US); Ghyslain Pelletier, Montreal (CA)

(73) Assignee: InterDigital Patent Holdings, Inc., Wilmington, DE (US)

(21) Appl. No.: 19/198,747

(22) Filed: May 5, 2025

(51) Int. Cl. H04W 28/02; H04J 13/10

(52) U.S. Cl. CPC H04W 28/0268; H04J 13/107

(57) ABSTRACT

A method may be implemented by a wireless transmit/receive unit (WTRU), and may include receiving configuration information, wherein the configuration information comprises one or more conditions associated with packet concatenating, and wherein the one or more conditions comprise a concatenation time window. A concatenated payload that comprises a plurality of protocol data units (PDUs) or a service data units (SDUs) may be generated based on the concatenation time window. One or more QoS parameters for the concatenated payload may be determined based on characteristics of the plurality of the PDUs or the SDUs included in the concatenated payload. The concatenated payload may be sent based on the one or more QoS parameters.

### BACKGROUND

Radio Link Control (RLC) concatenation was introduced in 3G Universal Mobile Telecommunications System (UMTS). The motivation is to concatenate multiple Internet Protocol (IP) packets with variable sizes from Packet Data Convergence Protocol (PDCP) to save signaling overhead (e.g., RLC header). It was specified that each RLC entity may need to do concatenation and/or segmentation of one or more PDCP protocol data units (PDUs) to one configured size RLC Payload Unit (PU), in which the size of the PU is configured per Radio Bearer (RB).

### SUMMARY

A wireless transmit/receive unit (WTRU) may be described herein. The WTRU may include a processor. The processor may be configured to receive configuration information. The configuration information may include one or more conditions associated with packet concatenating, and the one or more conditions may include a concatenation time window. The processor may be configured to generate, based on the concatenation time window, a concatenated payload that comprises a plurality of protocol data units (PDUs) or service data units (SDUs), and to determine one or more QoS parameters for the concatenated payload based on characteristics of the plurality of the PDUs or the SDUs included in the concatenated payload. The processor may be configured to send the concatenated payload based on the one or more QoS parameters.

The one or more QoS parameters may be associated with a QoS treatment profile. The processor may be configured to determine the QoS treatment profile for the concatenated payload based on the characteristics of the plurality of PDUs or the SDUs.

The processor may be configured to start a concatenation window timer based on the concatenation time window upon arrival of a PDU or an SDU of the plurality of PDUs or SDUs included in the concatenated payload in a buffer of the WTRU, and to generate the concatenated payload based on an expiration of the concatenation window timer.

The one or more conditions may include a threshold. The processor may be configured to generate the concatenated payload based on a number of available PDUs or SDUs exceeding the threshold.

The one or more conditions may include a threshold. The processor may be configured to generate the concatenated payload based on a remaining latency budget of the plurality of PDUs or SDUs included in the concatenated payload being less than the threshold.

The processor may be configured to determine to concatenate the plurality of PDUs or SDUs to generate the concatenated payload based on a respective QoS treatment profile associated with each PDU or SDU of the plurality of PDUs or SDUs.

The processor may be configured to maintain a discard timer (discardTimer) associated with each PDU or SDU in the concatenated payload and discard the concatenated payload if all associated discardTimers expire, and to determine the concatenated payload as delay-critical if a remaining time of at least one discardTimer is below a configured threshold.

The processor may be configured to determine a size of the concatenated payload based on at least one of a scheduled grant, an average size of one or more previous grants, a configured maximum size, or a configured minimum size, and to send the concatenated payload via a radio bearer (RB) that is different from an RB used for non-concatenated PDUs or SDUs.

The characteristics of the plurality of the PDUs or the SDUs in the concatenated payload may include one or more of a size of the PDUs or SDUs, a type of the PDUs or SDUs, a remaining latency budget associated with the PDUs or SDUs, an importance level associated with the PDUs or SDUs, or a discard timer associated with the PDUs or SDUs.

The processor may be configured to stop buffering and perform concatenation upon detecting that a time gap to an uplink grant is smaller than a configured threshold.

A method may be implemented by a wireless transmit/receive unit (WTRU), and may include receiving configuration information, wherein the configuration information comprises one or more conditions associated with packet concatenating, and wherein the one or more conditions comprise a concatenation time window. A concatenated payload that comprises a plurality of protocol data units (PDUs) or a service data units (SDUs) may be generated based on the concatenation time window. One or more QoS parameters for the concatenated payload may be determined based on characteristics of the plurality of the PDUs or the SDUs included in the concatenated payload. The concatenated payload may be sent based on the one or more QoS parameters.

The one or more QoS parameters are associated with a QoS treatment profile, and further comprising determining the QoS treatment profile for the concatenated payload based on the characteristics of the plurality of PDUs or the SDUs.

The method may include starting a concatenation window timer based on the concatenation time window upon arrival of a PDU or an SDU of the plurality of PDUs or SDUs included in the concatenated payload in a buffer of the WTRU, and generating the concatenated payload based on an expiration of the concatenation window timer.

The one or more conditions may include a threshold. The method may include generating the concatenated payload based on a number of available PDUs or SDUs exceeding the threshold.

The one or more conditions may include a threshold. The method may include generating the concatenated payload based on a remaining latency budget of the plurality of PDUs or SDUs included in the concatenated payload being less than the threshold.

The method may include determining to concatenate the plurality of PDUs or SDUs to generate the concatenated payload based on a respective QoS treatment profile associated with each PDU or SDU of the plurality of PDUs or SDUs.

The method may include maintaining a discard timer (discardTimer) associated with each PDU or SDU in the concatenated payload and discard the concatenated payload if all associated discardTimers expire, and determining the concatenated payload as delay-critical if a remaining time of at least one discardTimer is below a configured threshold.

The method may include determining a size of the concatenated payload based on at least one of a scheduled grant, an average size of one or more previous grants, a configured maximum size, or a configured minimum size, and sending the concatenated payload via a radio bearer (RB) that is different from an RB used for non-concatenated PDUs or SDUs.

The characteristics of the plurality of the PDUs or the SDUs in the concatenated payload may include one or more of a size of the PDUs or SDUs, a type of the PDUs or SDUs, a remaining latency budget associated with the PDUs or SDUs, an importance level associated with the PDUs or SDUs, or a discard timer associated with the PDUs or SDUs.

The method may include stopping buffering and performing concatenation upon detecting that a time gap to an uplink grant is smaller than a configured threshold.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example method for uplink layer 2 (L2) processing from reception of an uplink grant to delivery of a MAC PDU in a case of RLC concatenation according to an embodiment.

FIG. 3 is a diagram illustrating an example method for a packet concatenation procedure according to an embodiment.

FIG. 4 is a diagram illustrating an example method for performing concatenation at the SDAP layer using a WTRU according to an embodiment.

FIG. 5 is a diagram illustrating an example method for performing concatenation at the PDCP layer using a WTRU according to an embodiment.

FIG. 6 is a diagram illustrating an example method for concatenating SDUs and/or PDUs that arrive within a concatenation window according to an embodiment.

FIG. 7 is a diagram illustrating an example method for determining the size of a concatenated-Payload based on the remaining resource availability according to an embodiment.

FIG. 8 is a diagram illustrating an example method for mapping a concatenated-Payload to different RBs using a WTRU according to an embodiment.

FIG. 9 is a diagram illustrating another example method for a packet concatenation procedure according to an embodiment.

### DETAILED DESCRIPTION

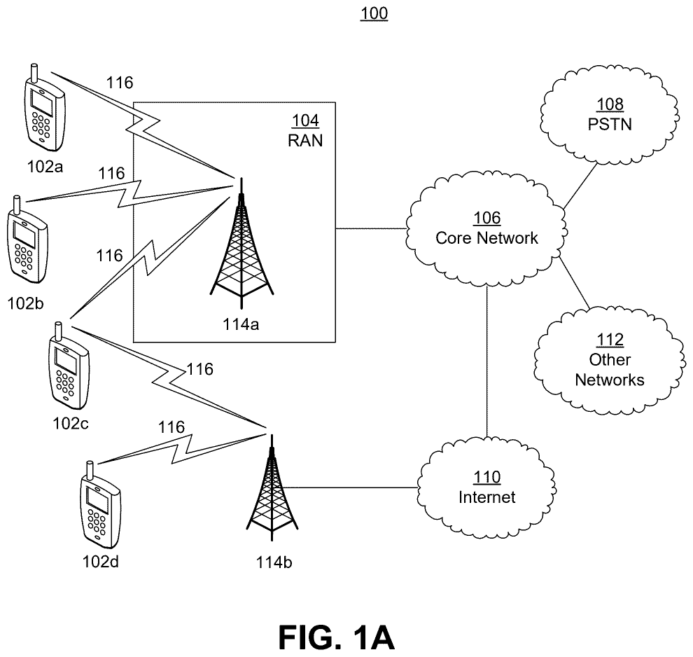

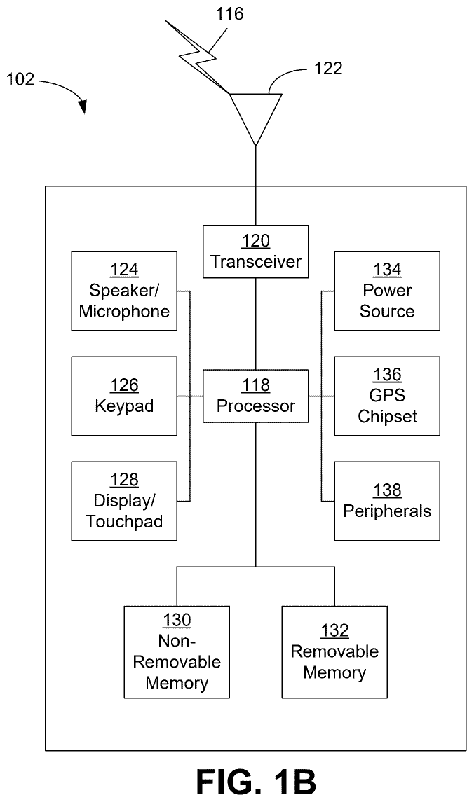

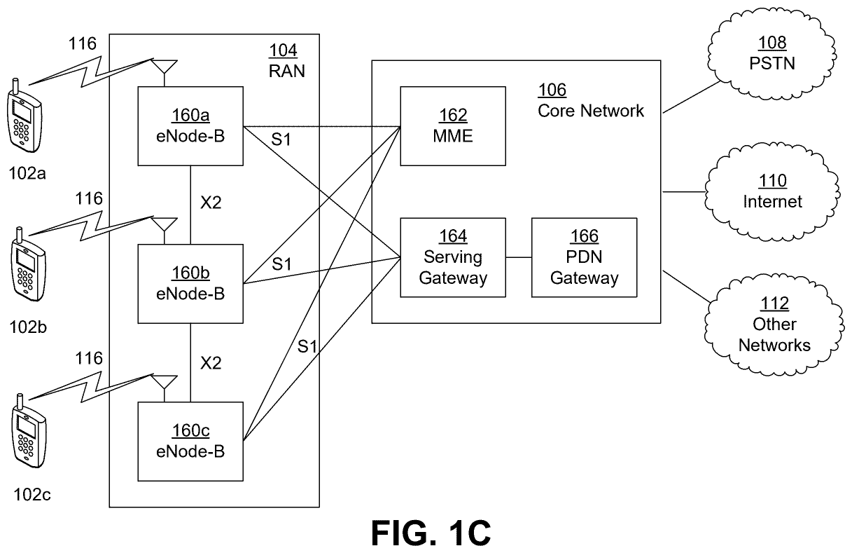

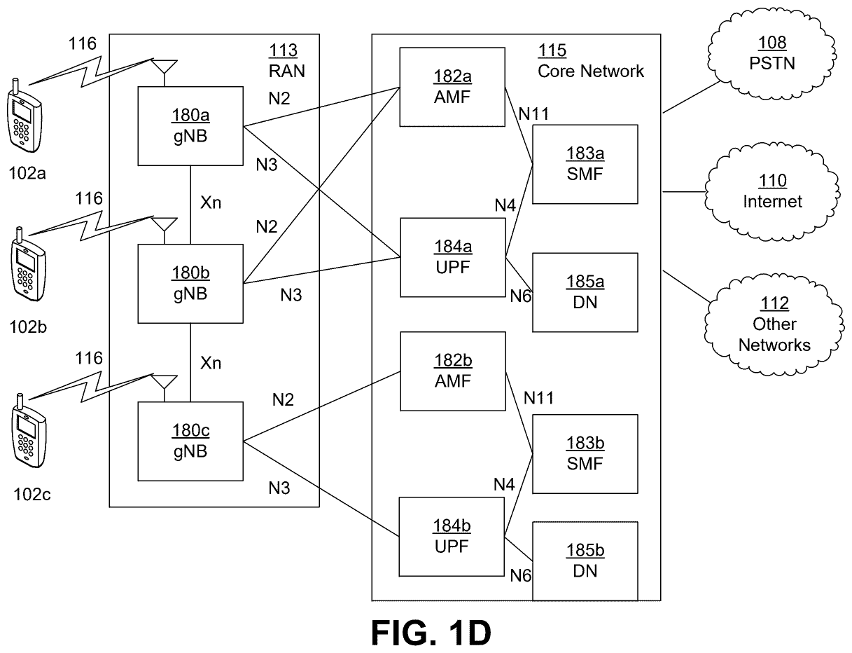

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In 4G Long Term Evolution (LTE), RLC concatenation and segmentation is still supported. However, how RLC performs concatenation and/or segmentation is indicated by Medium Access Control (MAC) to support much flexible Transport Block (TB) size. Specifically, the MAC layer may receive an uplink grant from the network, which may have flexible TB size. Before each uplink grant, MAC may perform Logical Channel Prioritization (LCP) to determine the amount of data in each Logical Channel (LCH) (RLC PDU size) to multiplex in the TB. RLC PDU size is indicated to each RLC entity to construct the indicated RLC PDU by using concatenation and/or segmentation. The following method may be used to indicate the method of User Plane (UP) processing from the time WTRU receives an uplink grant to delivery of MAC PDU.

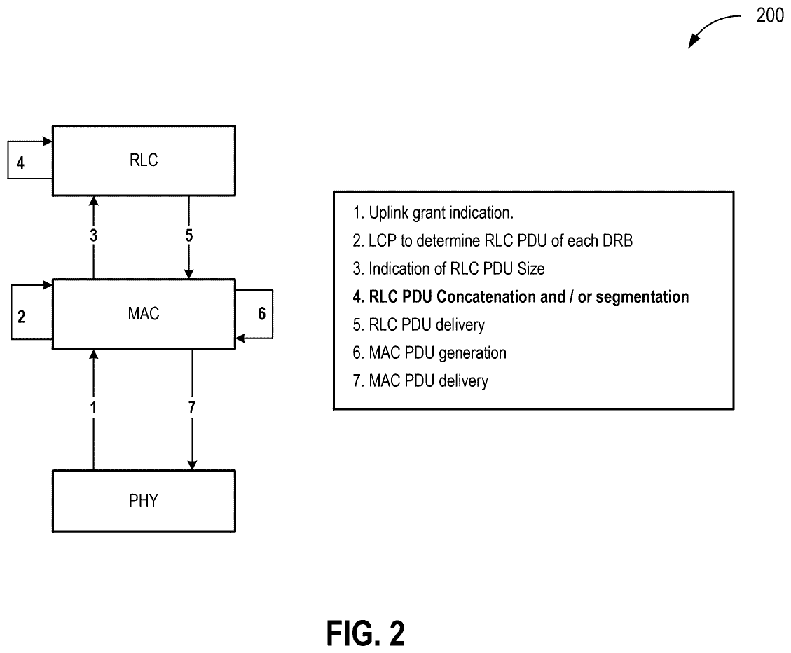

Referring now to FIG. 2, an example method 200 illustrating an L2 method from reception of uplink grant to delivery of MAC PDU in case of RLC concatenation is illustratively depicted.

Fifth Generation (5G) targets to support low latency and high data rate. However, concatenation may delay the Wireless Transmit/Receive Unit (WTRU) from generating RLC PDUs as the WTRU has to wait for the MAC to indicate the size of RLC PDU before each grant. Moreover, MAC also performs concatenation of RLC PDUs from multiple RBs. Therefore, RLC concatenation may be redundant and may delay the data delivering process. Based on these reasons, RLC concatenation is removed from 5G New Radio (NR).

It is expected that 6G may support an even higher data rate than 5G with variable size IP packets (e.g., from several bytes and/or bits (e.g., 40 bytes) to thousands of bytes (e.g., 9000 bytes)). It is also expected that 6G may support variable size of a MAC PDU from several bits up to about 40 kilobytes (kB). A 6G WTRU may be required to process a much higher number of IP packets within a duration compared to a 5G WTRU. One large size MAC PDU may contain many IP packets, especially for IP packets with small sizes.

It is expected that User Plane Integrity Protection (UPIP) will be supported as a mandatory feature as UPIP may help increase the integrity of the system. UPIP enables a receiver to determine whether the PDU is altered, modified, and/or not. UPIP requires the WTRU to perform integrity protection for each PDCP Service Data Unit (SDU). At the end of UPIP method for an SDU, Message Authentication Code for Integrity (MAC-I), which has 4 bytes, is added at the end of payload.

There may be an anticipated need to have a reduced number of headers for non-latency critical data (e.g., Artificial Intelligence/Machine Learning (AIML) collection data). Some small size PDU inference data and/or PDU additional data may also only be useful when received successfully.

The current system does not allow the Wireless Transmit/Receive Unit (WTRU) to concatenate Internet Protocol (IP) packets at higher layer (except at Medium Access Control (MAC)). Therefore, the WTRU needs to perform Layer 2 (L2) processing (e.g., ciphering, User Plane Integrity Protection (UPIP), adding Packet Data Convergence Protocol (PDCP) header, Radio Link Control (RLC) functions, and adding RLC header) for each IP packet, which may result in signaling overhead and computational complexity. Concatenation may help reduce the number of UPIP operations and L2 overhead in terms of the number of headers.

Configuration of concatenation per Quality of Service (QoS) flow and/or Radio Bearer (RB) on a semi-static basis may not be optimal for all scenarios because WTRU processing capability and/or requirement may be different from time to time. For example, the data arrival rate and characteristic may vary from time to time (e.g., bursty and/or non-bursty, high data rate and/or low data rate). The channel condition of the WTRU may dynamically change. The gap between data arrival and an uplink grant may vary based on the scheduling decision from the network.

The property of packets (e.g., Machine Learning (ML) and/or sensing data, protocol data unit (PDU) sets, importance, latency, and/or size) may be different (e.g., as a function of data, data type, and/or arrival time). For example, for some delay-critical data (e.g., prompt in mobile Artificial Intelligence (AI)), the WTRU should send the data as soon as possible. However, for non-delay-critical data (e.g., ML data and/or enhanced Mobile Broadband (eMBB) data), the WTRU may be able to wait in the buffer for a period without affecting the QoS (e.g., latency requirement). PDUs with common QoS requirement, treatment at the receiver, and delivery requirements may be considered when determining whether to bundle packets.

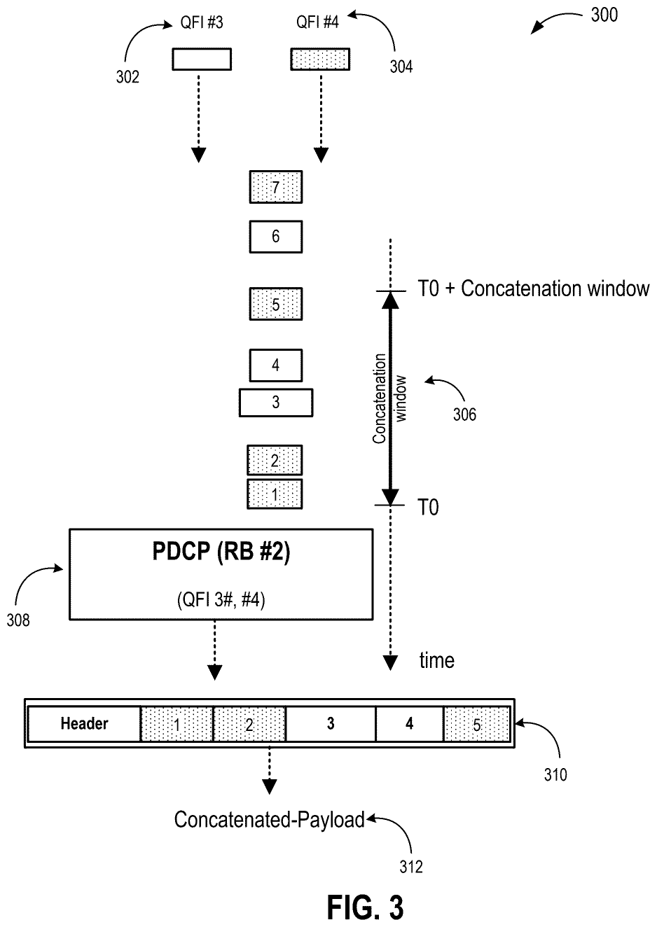

Referring now to FIG. 3, an example method 300 illustrating operation of concatenation over time for multiple QoS flows is illustratively depicted. A first packet associated with a first QoS Flow Identifier (QFI #3) 302 and a second packet associated with a second QFI (#4) 304 may arrive at different times. A concatenation window 306 may begin at a first time T0. A PDCP entity 308 for a given RB (e.g., RB #2) may receive the SDUs/PDUs for potential concatenation. A concatenated payload 310 may then be generated and output at 312.

A WTRU may be configured to opportunistically and selectively concatenate multiple packets (e.g., IP packets) at a higher layer (e.g., Service Data Adaptation Protocol (SDAP), PDCP, Radio Resource Control (RRC), and/or a newly introduced layer for concatenation) to reduce signaling overhead (e.g., number of headers) and WTRU processing (e.g., L2 processing such as ciphering and/or UPIP) while still guaranteeing the QoS requirement. A WTRU may be configured (e.g., according to configuration information) to evaluate what type of data, logical association, and/or conditions are present for concatenating data packets (e.g., packet concatenating). A WTRU may be configured to determine what criteria to apply to bundle and determine the number of concatenated packets within a data flow.

A WTRU may perform concatenation of Service Data Units (SDUs) and/or PDUs when a concatenation triggering condition is satisfied. The triggering condition may include an expiry of a concatenation window timer, a determination that the number of available SDUs and/or PDUs for concatenation is greater than a configured threshold, and/or a determination that the remaining latency budget is smaller than a configured threshold.

A WTRU may be pre-configured with one or more of the following parameters, per QoS treatment profile (RB and/or Logical Channel (LCH)), for packet concatenation. A concatenation window may be used to control the maximum buffering time of an SDU and/or PDU for concatenation. A size, including a minimum and/or maximum, associated with a concatenated payload after concatenation may be used. The QoS (e.g., the remaining latency budget) for an SDU and/or PDU to deliver the SDU and/or PDU for subsequent data treatment (e.g., UPIP and/or ciphering) may also be configured.

Upon arrival of each SDU and/or PDU subject for concatenation, the WTRU may start a concatenation window timer to buffer the SDU and/or PDU. The WTRU may perform concatenation of the SDUs and/or PDUs based on the concatenation condition being satisfied. For example, the WTRU may perform concatenation upon expiry of the concatenation window timer, upon determining that the number of available concatenable SDUs and/or PDUs is larger than a configured threshold, and/or upon determining that the remaining latency budget of an SDU and/or PDU is smaller than a configured threshold.

The WTRU may determine the QoS treatment profile and/or QoS parameters associated with the concatenated payload based on the characteristics of the SDUs and/or PDUs included in the concatenated payload. For example, the WTRU may determine the delay criticality of the concatenated payload based on the smallest remaining time of each running discard timer (discardTimer) associated with the SDUs and/or PDUs in the concatenated payload. The WTRU may determine to discard the concatenated payload if the discardTimers associated with all the SDUs and/or PDUs in the concatenated payload expire.

The WTRU may transmit the concatenated payload to a receiver.

The above-described configuration enables the WTRU to properly concatenate multiple IP packets, which may help the WTRU to minimize the L2 processing (e.g., ciphering and/or UPIP) and reduce the signaling overhead (e.g., reducing the number of headers) while maintaining the QoS requirements.

In examples, the WTRU may determine whether to (continue to) buffer an SDU and/or PDU for potential concatenation. The WTRU may determine which SDUs and/or PDUs to concatenate with one SDU and/or PDU. The WTRU may determine the size of the concatenated-Payload. The WTRU may determine when and/or whether to complete a concatenation process. The WTRU may determine the QoS treatment associated with a concatenated-Payload. The WTRU may determine the QoS parameters associated with a concatenated-Payload. The WTRU may maintain the timer associated with a concatenated-Payload. The WTRU may start a new timer for a concatenated-Payload. The WTRU may determine when and/or whether to deliver an SDU and/or PDU (e.g., a concatenated-Payload) to a lower layer.

Through the present disclosure, the terminology “network” may be used to describe a base station serving a Wireless Transmit/Receive Unit (WTRU), a next-generation NodeB (gNB), a Sixth Generation (6G) gNB, a Transmission Reception Point (TRP), a network entity such as a Location Management Function (LMF), and/or a coordinator device (e.g., a relay WTRU, another WTRU, and/or a group coordinator).

Throughout the present disclosure, the phrase “the WTRU is configured with something” may be used to indicate that the WTRU is preconfigured with a parameter or receives a network configuration of the parameter. The network configuration may be received via a System Information Block (SIB), a dedicated Radio Resource Control (RRC) message, a Medium Access Control Control Element (MAC CE), and/or Downlink Control Information (DCI). For example, the phrase “the WTRU is configured with a threshold” may be interpreted to mean that the WTRU is preconfigured with the threshold (e.g., the WTRU stores the configuration) and/or that the WTRU receives, from the network via the SIB, the RRC message, the MAC CE, and/or the DCI, the threshold.

In the present disclosure, the terms “indication from the network” and “configuration from the network” may be used interchangeably. Both expressions may describe the WTRU receiving a scheduling decision from the network. The WTRU may receive an indication and/or configuration from the network via any downlink reception such as a Synchronization Signal Block (SSB), a Master Information Block (MIB), the SIB, Non-Access Stratum (NAS), the RRC, the MAC CE, and/or the DCI.

A Radio Control Element (RCE) may be used to represent one or more control elements in any protocol layer, such as the Physical (PHY) layer (e.g., Low Power Wake-Up Signal (LP-WUS), Uplink Control Information (UCI), and the DCI), the MAC layer (e.g., the MAC CE), the Radio Link Control (RLC) layer (e.g., Control RLC), the Packet Data Convergence Protocol (PDCP) layer (e.g., Control PDCP), the Service Data Adaptation Protocol (SDAP) layer (e.g., Control SDAP), the RRC layer (e.g., an RRC message), and/or a new protocol introduced for new types of data handling such as Artificial Intelligence/Machine Learning (AIML), sensing, and/or computing (e.g., a control Data Plane Adaptation Protocol (DPAP)).

An application may provide one or more Internet Protocol (IP) flows for transmission over a medium. Each IP flow may then pass through a transport layer protocol (e.g., Transmission Control Protocol/Internet Protocol (TCP/IP), QUIC, Real-time Transport Protocol (RTP), and/or MOC). Each IP flow (e.g., a PDU session) may pass through a Radio Access Network (RAN) core network, which may map the IP flow to a RAN data flow and/or a RAN data set. For each RAN data flow, the core network may attach one or more QoS requirements, a QoS metric, and a range of Quality of Experience (QoE) metrics.

A RAN data flow may represent a logical association between data units, such as data units originating from the same IP flow. The association may be based on the data units being associated with the same IP flow and/or application flow, or based on a common packet marking by the core network and/or the application.

Some RAN data flows may not originate from a user application, but may instead originate from a control plane (e.g., control data and RAN signaling and configurations), an intelligence plane (e.g., data collected from AIML services), a computing plane (e.g., data used for native computing services), a system plane (e.g., data originating within the RAN such as from sensing and/or positioning services), and/or a security plane.

The WTRU may assign a QoS class to each control and/or data unit within a RAN data flow for purposes of characterizing how the control and/or data unit may be transmitted. A protocol plane may contain a classification function for marking the QoS class throughout the protocol chain. The QoS class may be determined in a given layer according to one or more configured and/or predefined rules. The QoS class may be used in various layers within the data plane protocol chain for achieving one or more QoS requirements. Each QoS class may be associated with a QoS treatment profile in the RAN, which may be configured semi-statically and/or updated dynamically. Each QoS treatment profile may include a number of parameters to control the RAN treatment of data transmission and/or reception, and may include a number of metrics to meet a QoS and/or QoE level for a given layer in the protocol chain. Each QoS class and/or QoS treatment profile may be associated and/or configured with one or more QoS parameters (e.g., a priority, an importance level, a delay bound, a reliability level, a guaranteed bit rate, a maximum bit rate, and/or a maximum packet loss rate).

In one solution, the WTRU may include one Service Data Unit (SDU) and/or Protocol Data Unit (PDU) in a buffer (e.g., in a concatenation layer such as SDAP, PDCP, RRC, RLC, MAC, and/or a new DPAP). The WTRU may determine whether to concatenate the SDU and/or PDU with one or more other SDUs and/or PDUs. Alternatively and/or additionally, the WTRU may determine whether to buffer or continue to buffer the SDU and/or PDU for potential concatenation. This determination—i.e., whether to concatenate the SDU and/or PDU with one or more other SDUs and/or PDUs and/or whether to buffer or continue to buffer the SDU and/or PDU—may be based on one or more of the following criteria.

The WTRU may determine whether concatenation (e.g., SDAP, PDCP, and/or RRC concatenation) is enabled or disabled. For example, the WTRU may receive a configuration (e.g., configuration information) and/or indication (e.g., via one or more RCEs) from the network indicating whether concatenation is enabled or disabled. If concatenation is disabled, the WTRU may not perform concatenation (e.g., packet concatenating) for the SDU and/or PDU. If concatenation is enabled, the WTRU may perform concatenation for the SDU and/or PDU.

The WTRU may evaluate the QoS, data, and/or service flow associated with the SDU and/or PDU. For example, for each QoS, data, and/or service flow, the WTRU may be configured with concatenation enabled or disabled. If the SDU and/or PDU is associated with a concatenation-enabled QoS, data, and/or service flow, the WTRU may buffer the SDU and/or PDU for potential concatenation. Otherwise, if the SDU and/or PDU is associated with a concatenation-disabled QoS, data, and/or service flow, the WTRU may deliver the SDU and/or PDU for subsequent treatment (e.g., ciphering and/or UPIP). This type of concatenation decision may be applicable when concatenation occurs at SDAP. In another example, the WTRU may be configured with one or more sets of QoS, data, and/or service flows for joint concatenation. If the QoS, data, and/or service flow associated with the SDU and/or PDU belongs to one of the configured sets, the WTRU may buffer the SDU and/or PDU for potential concatenation. Otherwise, the WTRU may deliver the SDU and/or PDU for subsequent treatment.

The WTRU may also determine whether a QoS treatment profile (e.g., RB, Logical Channel (LCH), and/or PDU-set) associated with the SDU and/or PDU is concatenation-enabled. For example, for each QoS treatment profile (e.g., RB, LCH, and/or PDU-set), the WTRU may be configured with concatenation enabled or disabled. If the SDU and/or PDU is associated with a concatenation-enabled QoS treatment profile, the WTRU may buffer the SDU and/or PDU for potential concatenation. Otherwise, if the SDU and/or PDU is associated with a concatenation-disabled QoS treatment profile, the WTRU may deliver the SDU and/or PDU for subsequent treatment (e.g., ciphering and/or UPIP). This type of decision may be applicable when concatenation occurs at PDCP. In another example, the WTRU may be configured with one or more sets of QoS treatment profiles (e.g., RB, LCH, and/or PDU-set) for joint concatenation. If the QoS treatment profile associated with the SDU and/or PDU belongs to one of the configured sets, the WTRU may buffer the SDU and/or PDU for potential concatenation. Otherwise, the WTRU may deliver the SDU and/or PDU for subsequent treatment.

The WTRU may determine whether to buffer an SDU and/or PDU for potential concatenation based on a QoS class marker associated with the SDU and/or PDU, which may be provided by an upper layer such as SDAP or NAS. The QoS marker associated with the SDU and/or PDU may implicitly and/or explicitly indicate whether the SDU and/or PDU is concatenable. If the SDU and/or PDU is concatenable, the WTRU may buffer the SDU and/or PDU for potential concatenation. Otherwise, if the SDU and/or PDU is not concatenable, the WTRU may perform subsequent treatment of the SDU and/or PDU (e.g., ciphering and/or UPIP). For example, the WTRU may receive an indication that a packet is associated with a Transmission Control Protocol (TCP) Acknowledgement/Negative Acknowledgement (ACK/NACK) protocol, which may not be concatenable. In such a case, the WTRU may not buffer the packet for concatenation and may instead deliver the packet for subsequent data treatment such as ciphering and/or UPIP.

The WTRU may determine whether to perform concatenation based on an indication received from a higher layer such as RRC, SDAP, or a newly introduced layer for data plane treatment associated with AIML data, sensing data, and/or other similar data types. For example, the WTRU may perform concatenation of one or more SDUs and/or PDUs at the PDCP layer. At the PDCP layer, the WTRU may receive an implicit and/or explicit indication, such as an indication in a header of the SDUs and/or PDUs, from a higher layer. The indication may inform the WTRU whether a given SDU and/or PDU is concatenable with one or more other SDUs and/or PDUs. If the SDU and/or PDU is concatenable, the WTRU may buffer the SDU and/or PDU for potential concatenation. Otherwise, if the SDU and/or PDU is not concatenable, the WTRU may deliver the SDU and/or PDU for subsequent data treatment, for example for security processing such as ciphering and/or UPIP.

The WTRU may determine whether to concatenate an SDU and/or PDU based on a property of the SDU and/or PDU, such as the size of the SDU and/or PDU or the type of SDU and/or PDU. The type of SDU and/or PDU may include a data SDU and/or PDU, a control SDU and/or PDU, AIML data, AIML training data, AIML inference data, AIML collection data, and/or sensing data. In one example, the WTRU may be configured with a minimum size and/or a maximum size of an SDU and/or PDU for concatenation. The WTRU may buffer the SDU and/or PDU if the size satisfies the configured thresholds. If the size does not satisfy the configured thresholds, the WTRU may deliver the SDU and/or PDU to a lower layer.

In another example, the WTRU may be configured to perform concatenation for SDUs and/or PDUs associated with one QoS treatment profile (e.g., RB, LCH, and/or PDU-set). The WTRU may determine to concatenate the SDU and/or PDU if it is a data SDU and/or PDU. The WTRU may determine not to concatenate a control PDU such as a control SDAP PDU and/or control PDCP PDU. The WTRU may determine whether the SDU and/or PDU is a control or data PDU based on a header of the SDU and/or PDU and/or based on an indication from an upper layer. For example, if the WTRU performs concatenation in the PDCP layer, the SDAP layer may indicate whether an SDAP SDU is a control SDU or a data SDU.

In another example, the WTRU may be configured with concatenation enabled or disabled for each type of SDU and/or PDU. The WTRU may determine to perform concatenation for an SDU and/or PDU if the SDU and/or PDU belongs to a type for which concatenation is enabled. Otherwise, if the SDU and/or PDU belongs to a concatenation-disabled type, the WTRU may deliver the SDU and/or PDU for subsequent treatment without waiting for concatenation. For example, for AIML data, the WTRU may be configured to perform concatenation for AIML training data such as AIML collection data. The WTRU may be configured not to perform concatenation for AIML inference data.

In another example, the WTRU may be configured to determine whether concatenation is enabled or disabled for each type of SDU and/or PDU. The WTRU may perform concatenation for the SDU and/or PDU if the SDU and/or PDU belongs to a type of SDU and/or PDU that is designated as concatenable. Otherwise, if the SDU and/or PDU belongs to a type designated as non-concatenable, the WTRU may not perform concatenation. For example, the WTRU may be configured to concatenate SDUs and/or PDUs associated with AIML data collection for model training. The WTRU may be configured not to perform concatenation for AIML data collection intended for AIML performance monitoring.

The WTRU may determine whether to buffer an SDU and/or PDU for potential concatenation based on QoS or QoE characteristics, such as the remaining latency budget or a priority or importance level associated with the SDU and/or PDU. In one example, the WTRU may buffer the SDU and/or PDU for potential concatenation if the remaining latency budget of the SDU and/or PDU is greater than a configured threshold. Otherwise, if the remaining latency budget is smaller than the configured threshold, the WTRU may deliver the SDU and/or PDU to a lower layer such as RLC and/or MAC. In another approach, the WTRU may perform concatenation of the SDU and/or PDU with one or more existing or available SDUs and/or PDUs, which may result in a smaller concatenated payload.

In another example, the WTRU may buffer one or more SDUs and/or PDUs for concatenation based on a comparison between the priority or importance level of the SDU and/or PDU and a configured threshold. If the priority or importance level is smaller or larger than a configured threshold, the WTRU may perform buffering for concatenation. Otherwise, if the priority or importance level is larger or smaller than the configured threshold, the WTRU may deliver the SDU and/or PDU to a lower layer for uplink transmission.

The WTRU may determine whether to continue buffering an SDU and/or PDU based on the duration the SDU and/or PDU has remained in the buffer. If the duration is smaller than a configured threshold, the WTRU may continue buffering the SDU and/or PDU for potential concatenation. Otherwise, if the duration exceeds the configured threshold, the WTRU may deliver the SDU and/or PDU for further treatment such as ciphering and/or UPIP. Alternatively, the WTRU may perform concatenation with one or more existing and/or available SDUs and/or PDUs, which may result in a smaller concatenated payload.

The WTRU may determine whether to buffer the SDU and/or PDU for potential concatenation based on the availability of one or more additional SDUs and/or PDUs in the buffer. In one example, the WTRU may buffer the SDU and/or PDU if there is at least a configured amount—such as a configured number of available SDUs and/or PDUs or a configured minimum size of aggregated SDUs and/or PDUs—available for potential concatenation. Otherwise, the WTRU may deliver the SDU and/or PDU for subsequent treatment such as ciphering and/or UPIP.

In another example, the WTRU may determine to concatenate the SDU and/or PDU with the available concatenable SDUs and/or PDUs into a concatenated payload if the total amount of the concatenable SDUs and/or PDUs, including the considered SDU and/or PDU, is greater than a configured threshold. This approach may enable the WTRU to perform concatenation as soon as the number or size of available SDUs and/or PDUs becomes sufficient, for example such that the resulting concatenated payload size exceeds a configured threshold.

The WTRU may determine whether to perform concatenation of an SDU and/or PDU based on the buffer status of the WTRU. The buffer status may include the amount of data in each QoS treatment profile such as an RB or LCH, a group of QoS treatment profiles such as a Logical Channel Group (LCG), and/or all QoS treatment profiles such as all reported LCGs. The buffer status may also include the amount of data satisfying one or more configured conditions, such as the amount of high-priority and/or high-importance data, the amount of delay-critical data, and/or the amount of data associated with one or more types of data such as AIML data and/or sensing data. For example, the WTRU may perform concatenation of an SDU and/or PDU if the amount of data associated with one QoS treatment profile, a configured set of QoS treatment profiles, and/or all QoS treatment profiles in the buffer is greater or smaller than a configured threshold. This approach may enable the network to prioritize transmission of other data while the considered SDU and/or PDU is waiting for concatenation.

The WTRU may determine whether to perform concatenation based on the size of a potential concatenated payload. The WTRU may perform concatenation of the SDU and/or PDU with one or more other SDUs and/or PDUs if the expected size of the concatenated payload satisfies a configured threshold, such as a minimum number of SDUs and/or PDUs or a minimum payload size. If the expected size of the concatenated payload is smaller than the configured minimum size, the WTRU may continue buffering the SDU and/or PDU until the configured minimum size is reached.

The WTRU may determine whether to buffer an SDU and/or PDU based on the measured channel condition, such as Reference Signal Received Power (RSRP). For example, the WTRU may buffer the SDU and/or PDU for potential concatenation if a measured RSRP value on the Uu interface is greater than a configured threshold. Otherwise, the WTRU may deliver the SDU and/or PDU to a lower layer.

The WTRU may determine whether to stop buffering the SDU and/or PDU and perform concatenation based on the time gap to an uplink grant for potential transmission of the SDU and/or PDU. For example, the WTRU may stop buffering the SDU and/or PDU and perform concatenation with the existing or available SDUs and/or PDUs if the time gap to the uplink grant is smaller or larger than a configured threshold. If the time gap to the uplink grant is larger or smaller than the configured threshold, the WTRU may continue buffering the SDU and/or PDU for potential concatenation. The time gap may be used to ensure that the WTRU has sufficient time to prepare a transport block (TB) for uplink transmission.

The WTRU may determine whether to stop buffering and perform concatenation of earlier-arrived SDUs and/or PDUs based on the arrival of a non-concatenable SDU and/or PDU. For example, if one or more non-concatenable SDUs and/or PDUs—such as a control SDAP PDU or a TCP ACK/NACK packet—arrive in a QoS treatment profile associated with an earlier-arrived SDU and/or PDU, the WTRU may stop buffering the earlier-arrived SDU and/or PDU. The WTRU may then concatenate the earlier-arrived SDUs and/or PDUs and deliver the resulting concatenated payload to a lower layer. This approach may enable the WTRU to maintain First-In-First-Out (FIFO) operation within its buffer, such that the earlier-arrived SDU and/or PDU is transmitted ahead of later-arriving SDUs and/or PDUs.

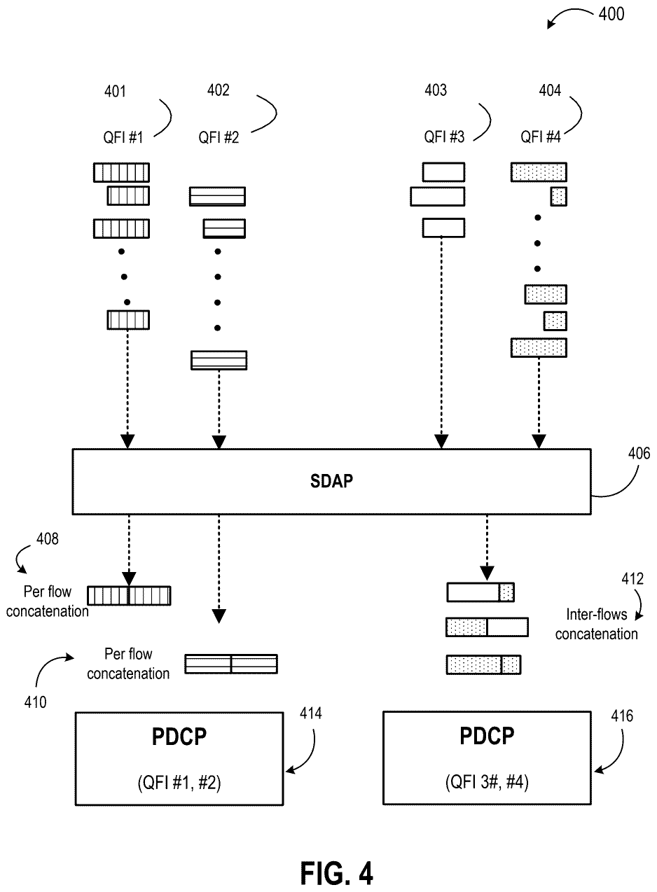

Referring now to FIG. 4, an example system 400 illustrating concatenation at the SDAP layer is illustratively depicted. In one example shown in FIG. 4, the WTRU may perform concatenation of multiple SDUs and/or PDUs at the SDAP layer 406. The WTRU may be configured to perform concatenation of SDUs and/or PDUs associated with the same QoS, data, and/or service flow. For example, the WTRU may be configured to perform concatenation of SDUs and/or PDUs within QoS Flow Identifier (QFI) #1 401. The WTRU may also be configured to perform concatenation of SDUs and/or PDUs within QFI #2 402. Additionally and/or alternatively, the WTRU may be configured to perform concatenation of SDUs and/or PDUs from different QoS, data, and/or service flows. For example, the WTRU may be configured to perform concatenation of SDUs and/or PDUs associated with QFI #3 403 and QFI #4 404. The WTRU may perform per-flow concatenation at 408 and 410, and inter-flow concatenation at 412, which may be subsequently delivered to PDCP instances 414 and 416 respectively.

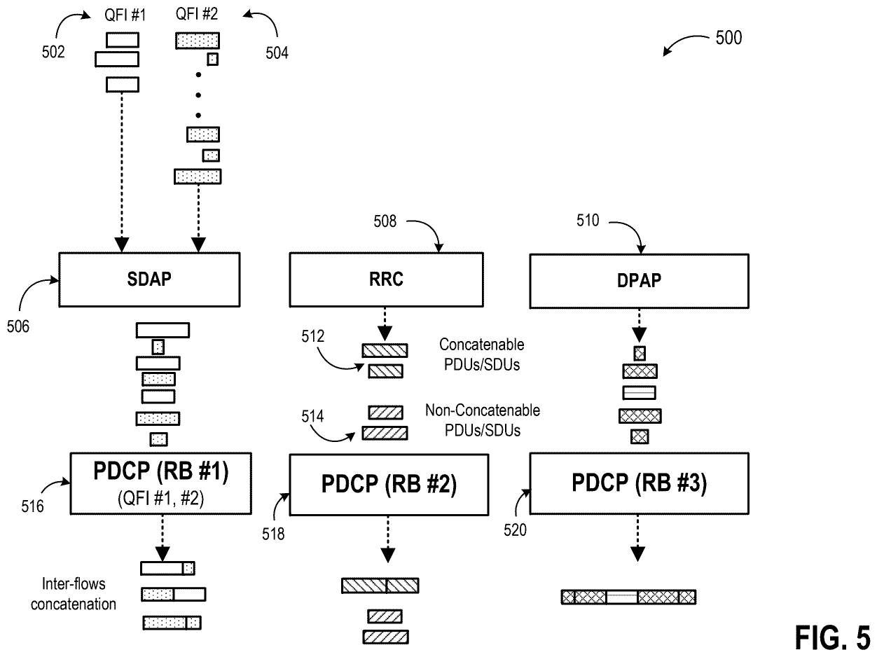

Referring now to FIG. 5, an example system 500 illustrating concatenation at the PDCP layer is illustratively depicted. In another example shown in FIG. 5, the WTRU may perform concatenation at the PDCP layer. The WTRU may be configured to perform concatenation of SDUs and/or PDUs from different upper layers, such as SDAP 506, RRC 508, and/or a new DPAP 510, which may be introduced to manage data associated with services such as AIML and/or sensing. The WTRU may concatenate SDUs and/or PDUs received from the same or different QoS, data, and/or service flows, for example, QFI #1 502 and/or QFI #2 504. The WTRU may also concatenate SDUs and/or PDUs received from control protocol sources such as RRC or DPAP, which may be used to generate and/or treat AIML and/or sensing data. The PDCP entities 516, 518, and 520 may receive an indication from RRC or DPAP as to whether each SDU and/or PDU is concatenable. Upon receiving the indication, the WTRU may concatenate those SDUs and/or PDUs indicated to be concatenable. The WTRU may deliver non-concatenable SDUs and/or PDUs for subsequent data treatment, such as security processing, including ciphering and/or UPIP.

In one solution, the WTRU may have one SDU and/or PDU subject to concatenation and may have one or multiple other SDUs and/or PDUs available to concatenate with the considered SDU and/or PDU. The considered SDU and/or PDU may be the first to arrive in the buffer, and the other SDUs and/or PDUs may arrive subsequently. In one approach, the WTRU may determine which SDUs and/or PDUs to concatenate with the considered SDU and/or PDU. In another approach, the WTRU may determine whether each SDU and/or PDU is concatenable with the considered SDU and/or PDU. In another approach, the WTRU may determine which group of SDUs and/or PDUs to concatenate together. Such a decision—i.e., which other SDUs and/or PDUs to concatenate with the considered SDU and/or PDU, whether a particular SDU and/or PDU is to be concatenated, and/or which group to concatenate together—may be based on one or a combination of the following:

The QoS, data, and/or service flow associated with the considered SDU and/or PDU and with each other SDU and/or PDU may be considered. In one example, the WTRU may prioritize concatenating SDUs and/or PDUs that are associated with the same QoS, data, and/or service flow. In another example, the WTRU may be configured with a set of QoS, data, and/or service flows for which joint concatenation is enabled. If the considered SDU and/or PDU belongs to one of the QoS, data, and/or service flows in the configured set, the WTRU may concatenate the considered SDU and/or PDU with one or more other SDUs and/or PDUs from the same set.

In one solution, the WTRU may have one SDU/PDU subject for concatenation. The WTRU may have one or multiple other SDUs/PDUs to concatenate with the considered SDU/PDU. The considered SDU/PDU may be the first arrival SDU/PDU and the other SDUs/PDUs may subsequently arrive at the buffer. The WTRU may determine which SDUs/PDUs to concatenate to the considered SDU/PDU. The WTRU may determine whether a certain SDUs/PDUs may be concatenated with the considered SDU/PDU. The WTRU may determine which SDUs/PDUs to concatenate together. Such decision (e.g., which other SDUs/PDUs to concatenate with the considered SDU/PDU and/or whether to concatenate an SDU/PDU with the considered SDU/PDU, and/or which SDUs/PDUs to concatenate together) may be determined based on one or any combination of the following.

The QoS/data/service flow associated with the considered SDU/PDU and each other SDU/PDU may be considered. The WTRU may prioritize to concatenate the SDUs/PDUs associated with the same QoS/data/service flow. The WTRU may be configured with a set of QoS/data/service flows with joint concatenation enabled. The considered SDU/PDU may belong to one QoS/data/service flow of the set. The WTRU may then concatenate the considered SDU/PDU with one or more other SDUs/PDUs in the same set of QoS/data/service flows with joint concatenation enabled.

A QoS treatment profile (e.g., RB/LCH/PDU-set) associated with each other SDU/PDU may also be considered. The considered SDU/PDU may be associated with a concatenation enabled QoS treatment profile (e.g., RB/LCH/PDU-set). The WTRU may then concatenate the considered SDU/PDU with one or more other SDUs/PDUs in the same QoS treatment profile (e.g., RB/LCH/PDU-set).

The property (e.g., the size, the type of the SDU/PDU such as data SDU/PDU, control SDU/PDU, AIML data, AIML training data, AIML inference data, AIML collection data, sensing data, sensing data) associated with the considered SDU/PDU and/or each other SDU/PDU may be considered. The WTRU may be configured with a size (e.g., the maximum and/or minimum size) of a concatenable SDU/PDU. The WTRU may then concatenate with the SDUs/PDUs satisfying the configured concatenable size. The WTRU may have multiple concatenable SDUs/PDUs. The WTRU may prioritize to concatenate with a smaller/larger size SDU/PDU. The WTRU may prioritize to concatenate with the SDU/PDU having a similar size with the considered SDU/PDU. The WTRU may prioritize to concatenate with an SDU/PDU having the size within a configured range (e.g., the size being larger than a minimum configured size and/or smaller than a maximum configured size). The WTRU may have multiple types of SDUs/PDUs to be concatenable with the considered SDU/PDU. The WTRU may then prioritize to concatenate with one or more SDUs/PDUs satisfying a configured condition. The WTRU may prioritize to concatenate with the SDUs/PDUs of the same type. The WTRU may be configured with a priority order for each type of SDU/PDU. The WTRU may then prioritize to concatenate with the SDU/PDU type of the smallest/largest priority order.

The QoS/QoE associated with the considered SDU/PDU and/or each other SDU/PDU may be considered. The WTRU may concatenate the SDUs/PDUs to one concatenated-Payload if the SDUs/PDUs does not have latency requirement or the (remaining) latency budget being greater than a configured threshold. This approach may be motivated to concatenate the SDUs/PDUs with very high latency budget to reduce the subsequent processing and number of headers for the concatenated SDUs/PDUs. The WTRU may have a considered SDU/PDU, which may have the (remaining) latency budget being greater than a configured threshold or may not have latency requirement. The WTRU may then concatenate the considered SDU/PDU with another SDU/PDU if the other SDU/PDU does not have latency requirement or the (remaining) latency budget is larger than the configured threshold. The WTRU may prioritize to concatenate the considered SDU/PDU with the highest priority/importance SDU/PDU. The WTRU may prioritize to concatenate the considered SDU/PDU with the lowest (remaining) latency budget SDU/PDU.

The relative QoS/QoE between the considered SDU/PDU and each other SDU/PDU may be considered. The relative QoS/QoE between two SDUs/PDUs may be determined based on the difference of one QoS/QoE parameter between two SDUs/PDUs. The relative (remaining) latency budget between two SDUs/PDUs may be determined based on the difference between the (remaining) latency budget of the two SDUs/PDUs. The relative priority between two SDUs/PDUs may be determined based on the priority difference between the two SDUs/PDUs. The WTRU may prioritize to concatenate the SDUs/PDUs with the smaller QoS difference. The WTRU may prioritize to concatenate the considered SDU/PDU with another SDU/PDU having a smaller relative (remaining) latency budget. The WTRU may prioritize to concatenate the considered SDU/PDU with another SDU/PDU having a smaller difference in priority/importance. The WTRU may prioritize to concatenate the SDUs/PDUs with the same Importance.

The destination (e.g., gNB, OTT server) associated with the considered SDU/PDU and each other SDU/PDU may be considered. The WTRU may prioritize to concatenate the SDUs/PDUs having the same destination (e.g., gNB, OTT server).

The relative arrival time between the considered SDU/PDU and each other SDUs/PDUs may also be considered. The WTRU may concatenate the SDUs/PDUs if the arrival time difference between two SDU/PDU is smaller than a configured threshold, in which the configured threshold may be associated with each QoS treatment profile (e.g., RB/LCH/PDU-set). The WTRU may only concatenate the SDUs/PDUs if the arrival time difference among the SDUs/PDUs is within a configured duration. The WTRU may have one considered SDU/PDU arriving at the buffer. Upon the arrival of the considered SDU/PDU, the WTRU may first start a concatenation window timer (e.g., concatenation time window) upon the arrival of the considered SDU/PDU. The WTRU may then consider the subsequent arrival SDUs/PDUs for concatenation with the considered SDU/PDU if the timer is still running. The WTRU may concatenate the SDUs/PDUs to a concatenated-Payload when the concatenation window expires or the amount of concatenable SDUs/PDUs is sufficient for concatenation. In this example, the concatenation window timer may be associated with each SDU/PDU, and it may be started when the SDU/PDU arrives at the buffer for concatenation. The WTRU may start a concatenation process, which may be started upon the arrival of a concatenable SDU/PDU. The WTRU may then start the concatenation window timer when the concatenation process is started. The WTRU may concatenate the SDUs/PDUs to a concatenated-Payload when the concatenation window expires or the amount of concatenable SDUs/PDUs is sufficient for concatenation. In this example, the concatenation window timer may be associated with each concatenation process, and it may be started when the WTRU initiates a concatenation process.

The arrival time of the SDU/PDU and/or the duration the SDU/PDU stays in the buffer may be considered. The WTRU may have multiple SDUs/PDUs for concatenation with the considered SDU/PDU. The WTRU may then prioritize to concatenate the considered SDU/PDU with the earliest arrival SDUs/PDUs.

The association between the considered SDU/PDU and the other SDUs/PDUs (e.g., the SDUs/PDUs in the same QoS/data/service flow, QoS treatment profile, PDU set, prompting request, one AIML data collection procedure, AIML model transfer procedure, and/or one inference output from the AIML) may be considered. The WTRU may prioritize to concatenate the SDUs/PDUs from one PDU set. The WTRU may be allowed to jointly concatenate the SDUs/PDUs from different QoS/data/service flows. The WTRU may prioritize to concatenate the SDUs/PDUs in the same QoS/data/service flow. The WTRU may have AIML data associated with one prompting request to an AIML model at OTT server. The WTRU may prioritize to concatenate the SDUs/PDUs associated with the same prompting request. The WTRU may have SDUs/PDUs associated with multiple AIML data collection reporting, in which one AIML data collection reporting may be associated with AIML beam management and another.

The joint QoE/QoS requirement associated with the SDUs/PDUs subject to concatenation may be considered. The WTRU may be configured for synchronized transmission of two or more SDUs/PDUs from the same or different QoS/data/service flows. The WTRU may then prioritize to concatenate the SDUs/PDUs associated with synchronization requirement. Specifically, the WTRU may have one considered SDU/PDU (e.g., the first arrival SDU/PDU subject for concatenation) at the concatenation layer. The WTRU may have multiple other SDUs/PDUs available for concatenation (e.g., subsequent arrival SDU/PDU). The WTRU may then prioritize one SDU/PDU to concatenate with if the SDU/PDU is required to be synchronized with the considered SDU/PDU. If the considered SDU/PDU is required to be synchronized with multiple SDUs/PDUs, the WTRU may prioritize to concatenate with the SDU/PDU requiring more stringent synchronization requirement (e.g., smaller synchronized window).

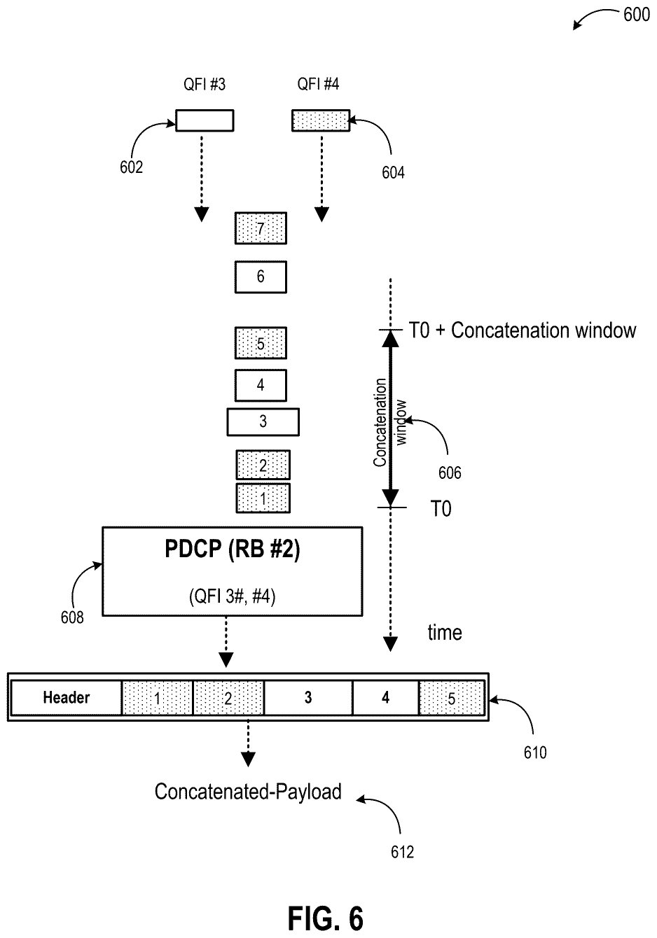

Referring now to FIG. 6, an example concatenation process 600 associated with a concatenation window is illustratively depicted. Specifically, upon arriving of an SDU/PDU (e.g., SDU #1) at time T0, the WTRU may first start a concatenation window timer 606. When the concatenation window timer 606 is running, the WTRU may have one or multiple subsequent SDUs/PDUs arriving. The WTRU may then concatenate the SDUs/PDUs arriving within the concatenation window (e.g., in the range [T0, T0+Concatenation window]) to a concatenated-Payload 612. Specifically, within the concatenation window, the WTRU may have five SDUs (SDU #1 to #5) from QFI #3 and QFI #4, shown at 602 and 604, arriving at the PDCP (RB #2) 608. The WTRU may then concatenate the five SDUs to one concatenated-Payload 612. The SDU #6 and #7 may not be concatenated in the concatenated-Payload 612 as they may arrive beyond the concatenation window.

The WTRU may be configured to concatenate the SDUs/PDUs with strict latency requirement such as the delay-critical SDUs/PDUs (e.g., SDUs/PDUs having (remaining) latency budget being smaller than a configured threshold). The WTRU may concatenate the SDUs/PDUs having the same/similar QoS requirement (e.g., SDUs/PDUs having the same/similar (remaining) latency requirement, SDUs/PDUs having the same priority/importance) and arriving at the buffer at the same/similar time (e.g., the SDUs/PDUs arrive in a burst). The WTRU may be configured with a short concatenation window timer so that the SDUs/PDUs may not stay in the buffer for a long period.

The WTRU may be configured to concatenate the SDUs/PDUs with relaxed latency requirements (e.g., SDUs/PDUs without latency requirement or the (remaining) latency budget being greater than a configured threshold). The WTRU may then concatenate the SDUs/PDUs together to a concatenated-Payload. The WTRU may be configured with a longer concatenation window timer so that the SDUs/PDUs may be able to stay in the buffer for longer period to wait for potential concatenation.

The WTRU may determine to stop the concatenation in response to either the corresponding concatenation window being expired/ended and/or the accumulated SDUs/PDUs to be concatenated reaching the size of an uplink grant.

Upon having multiple SDUs/PDUs for concatenation, the WTRU may determine the size (e.g., the payload, the number of included SDUs/PDUs) for each concatenated-Payload based on one or any combination of the following.

Indication/configuration from the network. The WTRU may be configured with a maximum, minimum, or exact size (e.g., the minimum/maximum/exact payload, the minimum/maximum/exact number of SDUs/PDUs in a concatenated-Payload) of a concatenated-Payload. The WTRU may then concatenate multiple SDUs/PDUs to a concatenated-Payload with the size being greater than the configured minimum and smaller than the maximum size. The WTRU may receive an indication from the network that the network may provide the grant having a certain size (e.g., an exact grant size value, a grant size greater than one threshold and/or smaller than another threshold). The WTRU may then determine to concatenate multiple SDUs/PDUs to one concatenated-Payload satisfying the indicated grant size value(s).

The set of available/concatenable SDUs/PDUs for concatenation within a concatenation window. The WTRU may be configured with a concatenation window to concatenate multiple SDUs/PDUs. The WTRU may concatenate the suitable SDUs/PDUs arriving within the concatenation window. The concatenation window may be started when the first SDU/PDU for concatenation of a concatenated-Payload arrives at the concatenation layer.

A preferred concatenated-Payload size may be indicated to the network. For example, the WTRU may first indicate its preferred size (e.g., minimum, maximum, or exact) of a concatenated-Payload. Such indication may be conveyed via an RCE (e.g., MAC-CE such as DSR/BSR). The WTRU may then perform concatenation of SDUs and/or PDUs to the size the WTRU indicates in the RCE. The WTRU may receive an acknowledge from the network to use the indicated size. The WTRU may perform concatenation of SDUs and/or PDUs to the confirmed size.

The size of the scheduled grant (e.g., a configured grant, a dynamic grant). The WTRU may be configured or indicated to use a grant for a set of concatenable QoS treatment profile(s). The WTRU may then concatenate multiple SDUs/PDUs associated with the set of QoS treatment profile(s) to fit the size of the scheduled grant, which may be used to transmit the concatenated-Payload. The WTRU may concatenate the SDUs/PDUs to the size of the grant if the gap to the grant is larger than a configured threshold.

The size associated to one or more previous grants, which may be the previous dynamic grant and/or configured grant. The previous grants may be used to transmit the concatenated-Payload associated with the same QoS treatment profile of the future concatenated-Payload. The WTRU may consider a configured number/window of the previous grants. The WTRU may then concatenate the SDUs/PDUs to the minimum, maximum, or average size of a configured number of the previous grants and/or to the minimum, maximum, or average size of the grants within a configured window.

The value of Bj/BSD/PBR associated with the QoS treatment profile (e.g., RB/LCH/PDU-set). The WTRU may concatenate the SDUs/PDUs associated with one QoS treatment profile (e.g., RB/LCH) so that the size of a concatenated-Payload is smaller than or equal to the bucket-level (Bj) associated with the QoS treatment profile. Alternatively, the WTRU may concatenate the SDUs/PDUs so that the size of a concatenated-Payload is smaller than or equal to BSD multiplied by PBR.

The remaining resource for the QoS treatment profile (e.g., RB/LCH/PDU-set) associated with the concatenated-Payload. For one scheduled grant, the WTRU may first determine the amount of data to be used for each QoS treatment profile, which may be determined based on the bucket-level (Bj) in the first multiplexing round and the amount of resource for the QoS treatment profile in the second multiplexing round. For the QoS treatment profile with concatenation enabled, the WTRU may then multiplex the SDUs/PDUs to a concatenated-Payload with the size to be equal to or smaller than the remaining resource for the QoS treatment profile. In case the WTRU has one or multiple non-concatenated SDU/PDU ahead of the concatenated-PDU, the WTRU may override FIFO operation by prioritizing the concatenated-Payload to be multiplexed in the grant. The WTRU may consider the SDUs/PDUs ahead of the concatenable SDUs/PDUs in the FIFO queue. The WTRU may then multiplex the concatenable SDUs/PDUs to a concatenated-Payload with the size to be equal to or smaller than the remaining resource after subtracting the resource for the SDUs/PDUs ahead of the concatenable SDUs/PDUs in the queue.

The availability of control/data (e.g., UCI, MAC-CE for CSI reporting and/or HARQ ACK/NACK) at lower layer. The WTRU may determine to concatenate up to one size (e.g., a first configured size) if the WTRU has pending control/data (UCI/MAC-CE) to be transmitted in a scheduled grant. Otherwise, if there is no pending control/data to be transmitted in the scheduled grant, the WTRU may determine to concatenate up to another size (e.g., the second configured size which may be larger than the first configured size).

The channel condition (e.g., Uu RSRP) of the WTRU. The WTRU may be configured with a maximum size of a concatenated-Payload as a function of the measured RSRP. If Uu RSRP is smaller than the first RSRP threshold, the WTRU may concatenate SDUs/PDUs to the first configured maximum or minimum size. Alternatively, if the Uu RSRP is smaller than the second RSRP threshold, the WTRU may concatenate SDUs/PDUs to the second configured maximum or minimum size.

Whether segmentation is performed for one or more last concatenated-Payloads. The WTRU may be configured with multiple possible sizes (e.g., multiple maximum, minimum, or exact sizes) of a concatenated-Payload. The WTRU may first concatenate the SDUs/PDUs to the first configured size (e.g., minimum, maximum, or exact size of the concatenated-Payload). The WTRU may reduce the size to the second configured size, which may be smaller than the first configured size, if one or multiple concatenated-Payloads associated with the first configured size was segmented. The WTRU may first concatenate the SDUs/PDUs to the first configured size. If a configured ratio of the concatenated-Payload is segmented, the WTRU may then concatenate the subsequent SDUs/PDUs to the second configured size, which may be smaller than the first configured size.

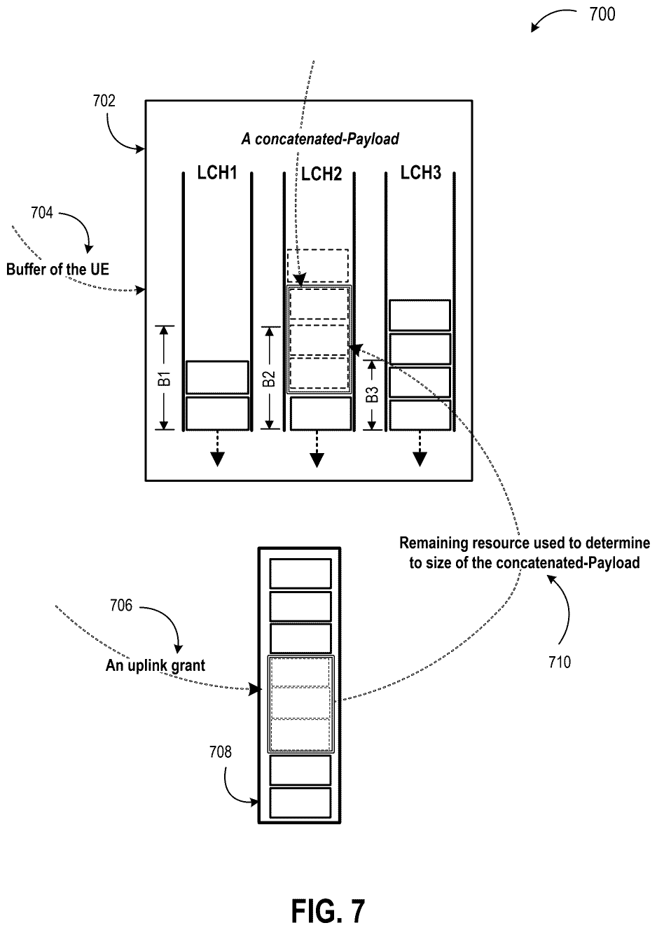

Referring now to FIG. 7, an example method 700 in which a wireless transmit/receive unit (WTRU) may determine the size of a concatenated-Payload based on the remaining resource for the concatenated-Payload is illustratively depicted. In some examples, the WTRU may first have an uplink grant 706 for potential transmission of the potential concatenated-Payload in logical channel (LCH) #2 within a buffer 702 of the WTRU (also referred to as the UE) 704. The WTRU may first determine the size of the concatenated-Payload by subtracting the resources for data in LCH #1, LCH #3 within PBR (e.g., bucket level B3), and the data in LCH #2 ahead of the concatenable SDUs/PDUs. Upon determination of the remaining resource 710 for the concatenated-Payload, the WTRU may then concatenate the SDUs/PDUs to be smaller than or equal to the remaining resource for the concatenated-Payload. For example, according to FIG. 7, the WTRU may determine that the remaining resource for the concatenated-Payload is 3 SDUs/PDUs. The WTRU may then concatenate 3 SDUs/PDUs to the concatenated-Payload 708 to multiplex the concatenated-Payload in the MAC PDU.

In one solution, the WTRU may start a concatenation process upon the arrival of one concatenable SDU/PDU, which may be used to buffer the SDU/PDU to wait for a potential concatenation with one or more SDUs/PDUs into one concatenated-Payload. Each concatenation process may be associated with one SDU/PDU. In one scenario, the concatenation process may be considered as complete if the SDU/PDU is concatenated to one concatenated-Payload. In another scenario, the SDU/PDU may not be concatenated. The concatenation process may be considered as complete if the SDU/PDU is delivered to subsequent data treatment (e.g., UPIP or ciphering). The WTRU may then determine when or whether to complete the concatenation process based on one or any combination of the following.

The arrival of sufficient SDUs/PDUs for concatenation may cause the WTRU to complete the concatenation process. For example, the WTRU may determine to complete the concatenation process if the amount of concatenable SDUs/PDUs (e.g., the number of concatenable SDUs/PDUs, the number of bytes associated with the concatenable SDUs/PDUs) is sufficient to concatenate a concatenated-Payload with the size being greater than a configured threshold.

The expiry of the concatenation window timer may also trigger completion of the concatenation process. For example, the WTRU may determine to complete the concatenation process associated with one SDU/PDU upon the expiry of the concatenation window timer, which may be initiated upon the arrival of the SDU/PDU. Upon expiry of the concatenation window timer, the WTRU may concatenate the SDU/PDU with the available or existing SDUs/PDUs to a concatenated-Payload if the size of the potential concatenated-Payload is larger than the minimum configured size. Alternatively, the WTRU may not concatenate the SDU/PDU with any other SDU/PDU and may deliver the SDU/PDU to subsequent data treatment (e.g., UPIP and security).

The QoE/QoS associated with the SDU/PDU may also be used to determine whether to complete the concatenation process. For example, the WTRU may stop the concatenation process for the SDU/PDU if the (remaining) latency budget of the SDU/PDU is smaller than a configured threshold. This approach may enable the SDU/PDU to be served within its delay budget. Specifically, the WTRU may not need to continue buffering the SDU/PDU for concatenation if the SDU/PDU becomes delay critical.

Explicit or implicit indication from the network may also be used to determine when to stop concatenation. In one example, the WTRU may receive an uplink grant for potential transmission of the SDU/PDU (e.g., AIML data collection), which may be implicitly or explicitly indicated in the DCI. The WTRU may then determine to stop the concatenation process for the SDU/PDU. The WTRU may deliver the SDU/PDU for subsequent data treatment (e.g., LCP) to transmit in the grant. Alternatively, the WTRU may concatenate the SDU/PDU with the available or existing SDUs/PDUs to a concatenated-Payload for transmission in the scheduled grant. In another example, the WTRU may receive an indication from the network to transmit a certain type of SDUs/PDUs (e.g., AIML data, sensing data). The WTRU may then stop buffering the SDU/PDU and make the SDU/PDU available for transmission. The WTRU may deliver the SDU/PDU for subsequent data treatment (e.g., LCP) to transmit in the grant. Alternatively, the WTRU may concatenate the SDU/PDU with the available or existing SDUs/PDUs to a concatenated-Payload for transmission in the scheduled grant.

In one example, the WTRU may first start a concatenation process for an SDU/PDU. The WTRU may be configured to concatenate a maximum of X SDUs/PDUs in one concatenated-Payload. If there are more than X concatenable SDUs/PDUs arriving at the buffer to concatenate with the considered SDU/PDU, the WTRU may then perform concatenation of the SDUs/PDUs and stop the concatenation process for the considered SDU/PDU. Alternatively, if the SDU/PDU stays in the buffer for a configured period, which may be configured per QoS treatment profile or per type of SDUs/PDUs, the WTRU may forward the SDU/PDU for subsequent data treatment. Additionally and/or alternatively, if the (remaining) latency budget of the SDU/PDU is smaller than a configured threshold, the WTRU may then forward the SDU/PDU for subsequent treatment.

A wireless transmit/receive unit (WTRU) may determine the QoS treatment associated with a concatenated-Payload. Upon concatenating multiple service data units (SDUs) and/or protocol data units (PDUs) into one concatenated-Payload, the WTRU may determine a QoS treatment profile (e.g., radio bearer (RB), logical channel (LCH), and/or PDU-set) associated with the concatenated-Payload based on one or any combination of the following.

The WTRU may determine the QoS treatment profile based on configuration from the network. Specifically, the WTRU may be configured with two QoS treatment profiles (e.g., RB, LCH, and/or PDU-set) for an SDU and/or PDU from one QoS/data/service flow, in which the WTRU may deliver the SDU and/or PDU to one QoS treatment profile if the SDU and/or PDU is not concatenated. Otherwise, if the SDUs and/or PDUs are concatenated to a concatenated-Payload, the WTRU may deliver the concatenated-Payload to another QoS treatment profile. For example, if concatenation is implemented at a Service Data Adaptation Protocol (SDAP) layer, the WTRU may deliver SDUs and/or PDUs from one QoS/data/service flow to one configured QoS treatment profile (e.g., one RB) if the SDUs and/or PDUs are not in a concatenated-Payload. Otherwise, for a concatenated-Payload, the WTRU may deliver it to another QoS treatment profile (e.g., RB). In another example, if concatenation is implemented at the Packet Data Convergence Protocol (PDCP) layer, the WTRU may deliver SDUs and/or PDUs from one RB to one configured LCH if the SDUs and/or PDUs are not part of a concatenated-Payload. Otherwise, for a concatenated-Payload, the WTRU may deliver it to another configured LCH. In another example, the WTRU may be configured with one QoS treatment profile (e.g., RB and/or LCH) to treat each concatenated-Payload. The QoS treatment profile may have different thresholds for delay-criticality (e.g., remainingTimeThreshold). For example, the QoS treatment profile may have a different initial value of a discardTimer, which may be initiated when a new concatenated-Payload is generated. The new discardTimer may be used to discard the concatenated-Payload and/or to determine the delay-criticality of the concatenated-Payload.

The WTRU may determine the QoS treatment profile based on the QoS treatment profile (e.g., RB, LCH, and/or PDU-set) associated with each SDU and/or PDU included in the concatenated-Payload. For example, the WTRU may concatenate SDUs and/or PDUs from multiple QoS/data/service flows, in which each QoS/data/service flow may be configured to map to one QoS treatment profile (e.g., RB and/or LCH). The WTRU may then determine the QoS treatment profile for the concatenated-Payload based on the associated QoS treatment profiles of the SDUs and/or PDUs in the concatenated-Payload. For example, the WTRU may map the concatenated-Payload to the QoS treatment profile associated with the SDU and/or PDU having the highest priority. In another example, the WTRU may concatenate two SDUs and/or PDUs associated with two different QoS/data/service flows, in which one QoS/data/service flow may be mapped to an acknowledged mode (AM) RB and the other QoS/data/service flow may be mapped to an unacknowledged mode (UM) RB. The WTRU may map the resulting concatenated-Payload to the AM RB.

The WTRU may determine the QoS treatment profile based on QoS parameters (e.g., remaining latency budget, priority, and/or importance) associated with each SDU and/or PDU in the concatenated-Payload. For example, the WTRU may be configured to map the concatenated-Payload to multiple possible QoS treatment profiles based on the QoS parameters associated with the SDUs and/or PDUs. The WTRU may map the concatenated-Payload to one QoS treatment profile (e.g., a highest priority QoS treatment profile) if the remaining latency budget of the SDUs and/or PDUs is smaller than a configured threshold. Otherwise, if the remaining latency budget is larger than the configured threshold, the WTRU may map the concatenated-Payload to another QoS treatment profile (e.g., a lower priority QoS treatment profile).

The WTRU may determine the QoS treatment profile based on a property (e.g., the size) associated with the concatenated-Payload. For example, the WTRU may map the concatenated-Payload to one QoS treatment profile (e.g., an RB and/or LCH handling large SDUs and/or PDUs) if the size of the concatenated-Payload is greater than a configured threshold. Otherwise, if the size of the concatenated-Payload is smaller than the configured threshold, the WTRU may map the concatenated-Payload to another QoS treatment profile (e.g., an RB and/or LCH handling small SDUs and/or PDUs).

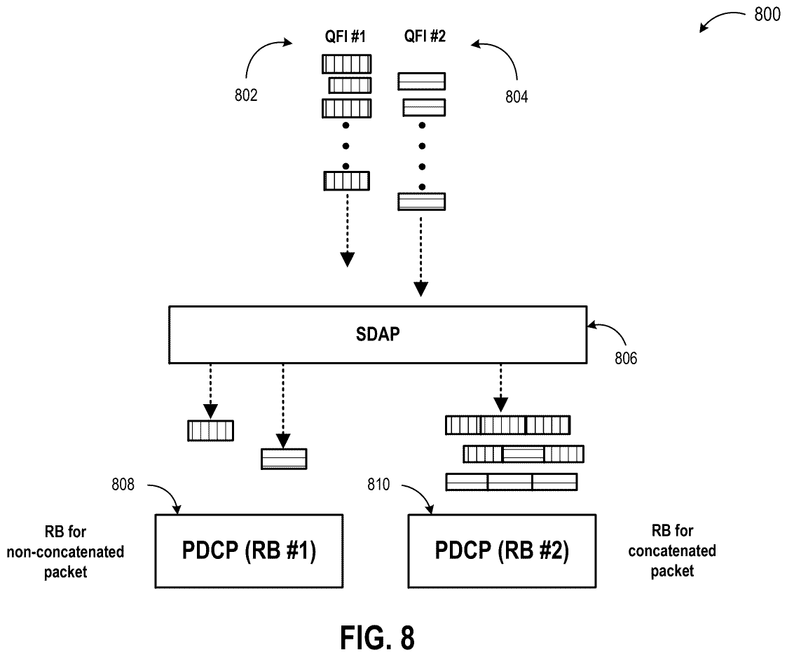

Referring now to FIG. 8, a method 800 for mapping a concatenated-Payload to different RBs using a WTRU is illustratively depicted. As shown, the WTRU may be configured with two radio bearers (e.g., RB #1 and RB #2) to map the SDUs/PDUs from QFI #1 802 and QFI #2 804. The WTRU may map the SDUs/PDUs to RB #1 via SDAP 806 and PDCP 808 if the SDUs/PDUs are not concatenated. For a concatenated packet, the WTRU may map the concatenated-Payload to RB #2 via PDCP 810.

The WTRU may determine one or more QoS parameters (e.g., (remaining) latency budget, priority, importance, reliability) associated with a concatenated-Payload. Upon concatenation of multiple SDUs/PDUs in one concatenated-Payload, the WTRU may determine these parameters based on one or any combination of the following.

The WTRU may determine one or more QoS parameters of the concatenated-Payload based on the QoS treatment profile (e.g., RB/LCH) associated with the QoS/data/service flows of the SDUs/PDUs in the concatenated-Payload. For example, the WTRU may determine the priority associated with the concatenated-Payload based on the highest priority of the associated QoS treatment profile mapped to the QoS/data/service flows of the SDUs/PDUs.

The WTRU may determine one or more QoS parameters of the concatenated-Payload based on the parameters associated with one or more SDUs/PDUs included in the concatenated-Payload. For example, the WTRU may determine the importance or priority of the concatenated-Payload based on the highest importance or priority of the SDUs/PDUs in the concatenated-Payload. The WTRU may determine reliability based on the highest reliability among the included SDUs/PDUs. For instance, if any SDU or PDU in the concatenated-Payload is associated with an acknowledged mode (AM) RB, the WTRU may map the concatenated-Payload to an AM RB. The WTRU may also determine the (remaining) latency budget of the concatenated-Payload based on the smallest (remaining) latency budget of the SDUs/PDUs in the concatenated-Payload. Alternatively, the WTRU may determine the (remaining) latency budget based on the largest (remaining) latency budget of the SDUs/PDUs.

The WTRU may maintain the timer(s) associated with a concatenated-Payload. Upon concatenation of multiple SDUs/PDUs, the WTRU may maintain the timers (e.g., discardTimer) originally associated with each SDU/PDU included in the concatenated-Payload. The WTRU may use one timer to represent the concatenated-Payload for subsequent data treatment. For discarding operations, the WTRU may discard the concatenated-Payload if all discardTimers of the SDUs/PDUs included in the concatenated-Payload expire. For delay-criticality determination, the WTRU may consider the concatenated-Payload as delay-critical if one of the discardTimers is smaller than a configured threshold (e.g., remainingTimeThreshold), which may be configured per discardTimer. Upon determining the concatenated-Payload as delay-critical, the WTRU may perform accelerated and/or differentiated treatment for the concatenated-Payload (e.g., accelerating polling, enabling autonomous retransmission, adjusting the priority of the associated QoS treatment, and/or reporting the DSR).

The WTRU may start a new timer for a concatenated-Payload. In another approach, the WTRU may start one or more new timers to represent the concatenated-Payload. These new timers may be used to determine the data treatment for the concatenated-Payload. For example, a timer may be used to discard the concatenated-Payload upon expiry, or may be used to trigger acceleration and/or differentiation of treatment when it reaches a configured value. The new timer(s) may be started when the first SDU/PDU arrives, when the last SDU/PDU arrives, or when the concatenated-Payload is generated. The value of one or more new timers may be determined based on one or any combination of the following:

The WTRU may determine the value of one or more new timers for the concatenated-Payload based on configuration from the network. For example, the WTRU may start a timer for discarding the concatenated-Payload and another timer for accelerating treatment. The WTRU may be configured with a dedicated initial value of the timer for a concatenated-Payload and with one or more dedicated thresholds to trigger accelerated treatment. Different timer values (e.g., for discardTimer) may be used to trigger polling, autonomous retransmission, adjusting the priority, and/or reporting the DSR. Upon reaching a configured value, the WTRU may trigger the associated accelerated treatment.

The WTRU may determine the value of a new timer based on the value of the timer associated with each SDU/PDU. For example, the WTRU may start a timer (e.g., Payload-discardTimer) used to discard a concatenated-Payload. The value of this timer may be based on the largest or the smallest value of the discardTimer associated with the SDUs/PDUs. Similarly, the WTRU may start a timer (e.g., Payload-DelayCriticalTimer) used to accelerate data treatment or scheduling of the concatenated-Payload (e.g., autonomous retransmission, polling enhancement, QoS profile adjustment, and/or DSR triggering). The value of this timer may likewise be based on the largest or smallest discardTimer value among the SDUs/PDUs.

The WTRU may determine the value of a new timer based on the QoS associated with each SDU/PDU in the concatenated-Payload. For example, the WTRU may start a timer to accelerate data treatment, where the value of the timer is based on the lowest remaining delay budget of the SDUs/PDUs in the concatenated-Payload. Alternatively, the WTRU may start a timer to discard the concatenated-Payload, where the timer value is based on the highest remaining delay budget.

The WTRU may determine the value of one or more new timers based on the QoS treatment profile associated with the concatenated-Payload. For example, the WTRU may be configured with a specific QoS treatment profile (e.g., RB/LCH) for a concatenated-Payload. For that profile, the WTRU may be configured with one or more timers (e.g., Payload-discardTimer, Payload-DelayCriticalTimer) and/or one or more thresholds used to trigger accelerated treatment of the concatenated-Payload.

The WTRU may determine when and/or whether to deliver an SDU and/or PDU (e.g., a concatenated-Payload) to a lower layer (e.g., PDCP layer when concatenation is at SDAP, RLC layer when concatenation is at PDCP, and MAC layer when concatenation is at RLC) and/or to make the SDU and/or PDU available for transmission. This determination may be based on one or any combination of the following.

The WTRU may determine to deliver the SDU and/or PDU based on explicit and/or implicit indication from the network. For example, the WTRU may receive a request from the network to deliver the SDU and/or PDU to the lower layer and/or to make the data available for transmission. The WTRU may then follow the request from the network. In another example, the WTRU may receive a grant for potential transmission of the SDU and/or PDU. The WTRU may then deliver the SDU and/or PDU to the lower layer for potential transmission using the scheduled grant.

The WTRU may determine to deliver the SDU and/or PDU based on the buffer status of the WTRU, which may include the amount of data satisfying a certain condition (e.g., data having higher priority and/or the amount of data ahead of the SDU and/or PDU). For example, the WTRU may deliver the data from SDAP to PDCP if the amount of data in the buffer of the WTRU (e.g., in PDCP and/or RLC buffer) is smaller than a configured threshold. In another example, the WTRU may deliver the SDU and/or PDU from SDAP to PDCP if the amount of higher priority data in the buffer is smaller than a configured threshold. In another example, the WTRU may deliver the SDU and/or PDU from SDAP to PDCP if the amount of data ahead of the SDU and/or PDU is smaller than a configured threshold.

The WTRU may determine to deliver the SDU and/or PDU based on the availability of a scheduled grant for potential transmission of the SDU and/or PDU. For example, the WTRU may deliver the SDU and/or PDU to the lower layer if the WTRU has a grant within a configured gap.

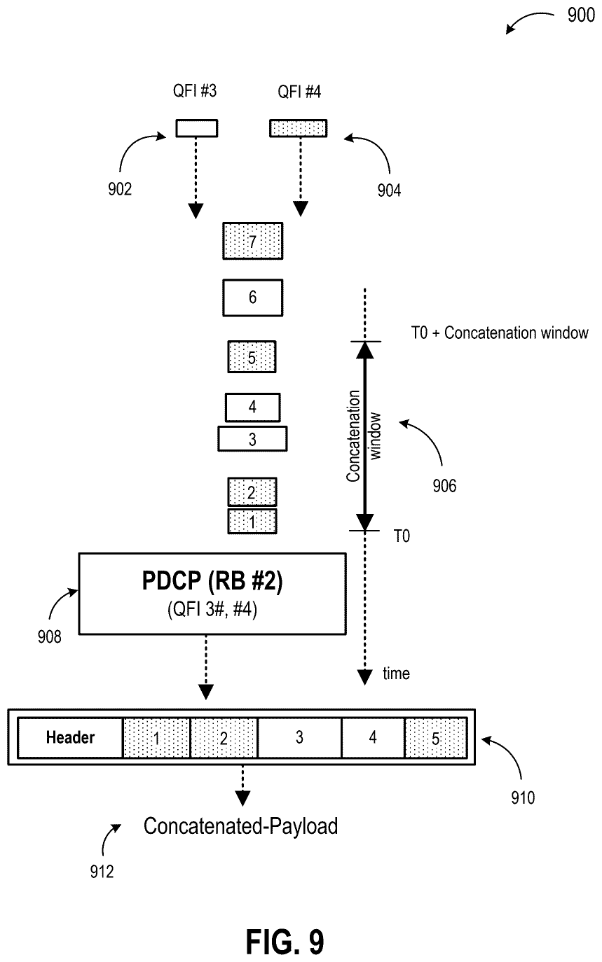

Referring now to FIG. 9, an example method 900 for a concatenation procedure is illustratively depicted. A wireless transmit/receive unit (WTRU) may perform concatenation of SDUs and/or PDUs associated with a QoS treatment profile when a concatenation triggering condition is satisfied. The triggering condition may include the expiry of a concatenation window timer, the amount of available SDUs and/or PDUs for concatenation being greater than a configured threshold, and/or the (remaining) latency budget of one or more SDUs and/or PDUs being smaller than a configured threshold.

The WTRU may be pre-configured with one or more concatenation parameters per QoS treatment profile (e.g., radio bearer (RB), logical channel (LCH)). These parameters may include a concatenation window, which may be used to control the maximum buffering time of an SDU and/or PDU for concatenation; a configured size (e.g., minimum and/or maximum) associated with a concatenated-Payload after concatenation; and/or a QoS parameter (e.g., the (remaining) latency budget) to determine whether to deliver the SDU and/or PDU for subsequent data treatment (e.g., user plane integrity protection (UPIP), ciphering).

Upon arrival of each SDU and/or PDU subject to concatenation, the WTRU may start a concatenation window timer to buffer the SDU and/or PDU. As shown in FIG. 9, SDUs and/or PDUs from different QoS flows (e.g., QFI #3 (902) and QFI #4 (904)) may be buffered in the concatenation layer (e.g., at PDCP 908) with a timer (906) started upon arrival at T0. The WTRU may then perform concatenation when the concatenation condition is satisfied. For example, the WTRU may concatenate the buffered SDUs and/or PDUs when the concatenation window timer expires, when the amount of concatenable SDUs and/or PDUs is larger than a configured threshold, and/or when the (remaining) latency budget of one or more SDUs and/or PDUs is smaller than a configured threshold.

The WTRU may determine the QoS treatment profile and/or QoS parameters associated with the resulting concatenated-Payload (910) based on the characteristics of the set (e.g., plurality) of SDUs and/or PDUs included in the concatenated-Payload. For example, the WTRU may determine the delay criticality of the concatenated-Payload based on the smallest remaining time of each running discardTimer associated with the SDUs and/or PDUs in the concatenated-Payload. The WTRU may also determine to discard the concatenated-Payload if the discardTimers associated with all the SDUs and/or PDUs in the concatenated-Payload have expired.

After concatenation, the WTRU may transmit the concatenated-Payload (912) to the receiver, enabling more efficient data processing.

This solution enables the WTRU to properly concatenate multiple IP packets, which may help minimize layer 2 (L2) processing (e.g., ciphering, UPIP) and reduce signaling overhead (e.g., reducing the number of headers) while maintaining the QoS requirements.

1. A wireless transmit/receive unit (WTRU) comprising:
a processor configured to:
receive configuration information, wherein the configuration information comprises one or more conditions associated with packet concatenating, and wherein the one or more conditions comprise a concatenation time window;
generate, based on the concatenation time window, a concatenated payload that comprises a plurality of protocol data units (PDUs) or service data units (SDUs);
determine one or more QoS parameters for the concatenated payload based on characteristics of the plurality of the PDUs or the SDUs included in the concatenated payload; and
send the concatenated payload based on the one or more QoS parameters.

2. The WTRU of claim 1, wherein the one or more QoS parameters are associated with a QoS treatment profile, and wherein the processor is configured to determine the QoS treatment profile for the concatenated payload based on the characteristics of the plurality of PDUs or the SDUs.

3. The WTRU of claim 1, wherein the processor is configured to:
start a concatenation window timer based on the concatenation time window upon arrival of a PDU or an SDU of the plurality of PDUs or SDUs included in the concatenated payload in a buffer of the WTRU; and
generate the concatenated payload based on an expiration of the concatenation window timer.

4. The WTRU of claim 1, wherein the one or more conditions comprise a threshold, and wherein the processor is configured to generate the concatenated payload based on a number of available PDUs or SDUs exceeding the threshold.

5. The WTRU of claim 1, wherein the one or more conditions comprise a threshold, and wherein the processor is configured to generate the concatenated payload based on a remaining latency budget of the plurality of PDUs or SDUs included in the concatenated payload being less than the threshold.

6. The WTRU of claim 1, wherein the processor is configured to determine to concatenate the plurality of PDUs or SDUs to generate the concatenated payload based on a respective QoS treatment profile associated with each PDU or SDU of the plurality of PDUs or SDUs.

7. The WTRU of claim 1, wherein the processor is configured to:
maintain a discard timer (discardTimer) associated with each PDU or SDU in the concatenated payload and discard the concatenated payload if all associated discardTimers expire; and
determine the concatenated payload as delay-critical if a remaining time of at least one discardTimer is below a configured threshold.

8. The WTRU of claim 1, wherein the processor is configured to:
determine a size of the concatenated payload based on at least one of a scheduled grant, an average size of one or more previous grants, a configured maximum size, or a configured minimum size; and
send the concatenated payload via a radio bearer (RB) that is different from an RB used for non-concatenated PDUs or SDUs.

9. The WTRU of claim 1, wherein the characteristics of the plurality of the PDUs or the SDUs in the concatenated payload comprise one or more of a size of the PDUs or SDUs, a type of the PDUs or SDUs, a remaining latency budget associated with the PDUs or SDUs, an importance level associated with the PDUs or SDUs, or a discard timer associated with the PDUs or SDUs.

10. The WTRU of claim 1, wherein the processor is configured to stop buffering and perform concatenation upon detecting that a time gap to an uplink grant is smaller than a configured threshold.

11. A method implemented by a wireless transmit/receive unit (WTRU), the method comprising:
receiving configuration information, wherein the configuration information comprises one or more conditions associated with packet concatenating, and wherein the one or more conditions comprise a concatenation time window;
generating, based on the concatenation time window, a concatenated payload that comprises a plurality of protocol data units (PDUs) or a service data units (SDUs) ;
determining one or more QoS parameters for the concatenated payload based on characteristics of the plurality of the PDUs or the SDUs included in the concatenated payload; and
sending the concatenated payload based on the one or more QoS parameters.

12. The method of claim 11, wherein the one or more QoS parameters are associated with a QoS treatment profile, and further comprising determining the QoS treatment profile for the concatenated payload based on the characteristics of the plurality of PDUs or the SDUs.

13. The method of claim 11, further comprising:
starting a concatenation window timer based on the concatenation time window upon arrival of a PDU or an SDU of the plurality of PDUs or SDUs included in the concatenated payload in a buffer of the WTRU; and
generating the concatenated payload based on an expiration of the concatenation window timer.

14. The method of claim 11, wherein the one or more conditions comprise a threshold, and further comprising generating the concatenated payload based on a number of available PDUs or SDUs exceeding the threshold.

15. The method of claim 11, wherein the one or more conditions comprise a threshold, and further comprising generating the concatenated payload based on a remaining latency budget of the plurality of PDUs or SDUs included in the concatenated payload being less than the threshold.

16. The method of claim 11, further comprising determining to concatenate the plurality of PDUs or SDUs to generate the concatenated payload based on a respective QoS treatment profile associated with each PDU or SDU of the plurality of PDUs or SDUs.

17. The method of claim 11, further comprising:
maintaining a discard timer (discardTimer) associated with each PDU or SDU in the concatenated payload and discard the concatenated payload if all associated discardTimers expire; and
determining the concatenated payload as delay-critical if a remaining time of at least one discardTimer is below a configured threshold.

18. The method of claim 11, further comprising:
determining a size of the concatenated payload based on at least one of a scheduled grant, an average size of one or more previous grants, a configured maximum size, or a configured minimum size; and
sending the concatenated payload via a radio bearer (RB) that is different from an RB used for non-concatenated PDUs or SDUs.

19. The method of claim 11, wherein the characteristics of the plurality of the PDUs or the SDUs in the concatenated payload comprise one or more of a size of the PDUs or SDUs, a type of the PDUs or SDUs, a remaining latency budget associated with the PDUs or SDUs, an importance level associated with the PDUs or SDUs, or a discard timer associated with the PDUs or SDUs.

20. The method of claim 11, further comprising stopping buffering and performing concatenation upon detecting that a time gap to an uplink grant is smaller than a configured threshold.
